(19) United States
(12) Patent Application Publication
(10) Pub. No.: US 2002/0066081 A1
(43) Pub. Date: May 30, 2002

(54) Speculative caching scheme for fast emulation through statically predicted execution traces in a caching dynamic translator

(76) Inventors: Evelyn Duesterwald, Somerville, MA (US); Vasanth Bala, Sudbury, MA (US); Sanjeev Banerjia, Cambridge, MA (US)

Correspondence Address: HEWLETT-PACKARD COMPANY, Intellectual Property Administration, P.O. Box 272400, Fort Collins, CO, 80527-2400, US

(21) Appl. No.: 09/756,019

(22) Filed: Jan. 5, 2001

Related U.S. Application Data
(60) Provisional application No. 60/184,624, filed on Feb. 9, 2000.

(51) Int. Cl. G06F 9/44

(52) U.S. Cl. 717/128; 717/141

(57) ABSTRACT

A system and method for growing a hot trace in a program during the program's execution in a dynamic translator, comprising the steps of: identifying an initial block as the first block in a trace to be selected; until an end-of-trace condition is reached, applying static branch prediction rules to the terminating branch of a last block in the trace to identify a next block to be added to the selected trace; and adding the identified next block to the selected trace.

This application claims the benefit of priority of provisional application No. 60/184,624, filed on Feb. 9, 2000, the content of which is incorporated herein in its entirety.

### FIELD OF THE INVENTION

The present invention relates to techniques for identifying portions of computer programs that are frequently executed. The present invention is particularly useful in dynamic translators needing to identify candidate portions of code for caching and/or optimization.

### BACKGROUND

Dynamic emulation is the core execution mode in many software systems including simulators, dynamic translators, tracing tools and language interpreters. The capability of emulating rapidly and efficiently is critical for these software systems to be effective. Dynamic caching emulators (also called dynamic tranlators) translate one sequence of instructions into another sequence of instructions which is executed. The second sequence of instructions are ‘native’ instructions—they can be executed directly by the machine on which the translator is running (this ‘machine’ may be hardware or may be defined by software that is running on yet another machine with its own architecture). A dynamic translator can be designed to execute instructions for one machine architecture (i.e., one instruction set) on a machine of a different architecture (i.e., with a different instruction set). Alternatively, a dynamic translator can take instructions that are native to the machine on which the dynamic translator is running and operate on that instruction stream to produce an optimized instruction stream. Also, a dynamic translator can include both of these functions (translation from one architecture to another, and optimization).

A traditional emulator interprets one instruction at a time, which usually results in excessive overhead, making emulation practically infeasible for large programs. A common approach to reduce the excessive overhead of one-instruction-at-a-time emulators is to generate and cache translations for a consecutive sequence of instructions such as an entire basic block. A basic block is a sequence of instructions that starts with the target of a branch and extends up to the next branch.

Caching dynamic translators attempt to identify program hot spots (frequently executed portions of the program, such as certain loops) at runtime and use a code cache to store translations of those frequently executed portions. Subsequent execution of those portions can use the cached translations, thereby reducing the overhead of executing those portions of the program.

Accordingly, instead of emulating an individual instruction at some address x, an entire basic block is fetched starting from x, and a code sequence corresponding to the emulation of this entire block is generated and placed in a translation cache. See B Cmelik, D. Keppel, “Shade: A fast instruction-set simulator for execution profiling,” Proceedings of the 1994 ACM SIGMETRICS Conference on Measurement and Modeling of Computer Systems. An address map is maintained to map original code addresses to the corresponding translation block addresses in the translation cache. The basic emulation loop is modified such that prior to emulating an instruction at address x, an address looked-up determines whether a translation exists for the address. If so, control is directed to the corresponding block in the cache. The execution of a block in the cache terminates with an appropriate update of the emulator's program counter and a branch is executed to return control back to the emulator.

As noted above, a dynamic translator may take instructions in one instruction set and produce instructions in a different instruction set. Or, a dynamic translator may perform optimization: producing instructions in the same instruction set as the original instruction stream. Thus, dynamic optimization is a special native-to-native case of dynamic translation. Or, a dynamic translator may do both—converting between instruction sets as well as performing optimization.

In general, the more sophisticated the hot spot detection scheme, the more precise the hot spot identification can be, and hence (i) the smaller the translated code cache space required to hold the more compact set of identified hot spots of the working set of the running program, and (ii) the less time spent translating hot spots into native code (or into optimized native code). The usual approach to hot spot detection uses an execution profiling scheme. Unless special hardware support for profiling is provided, it is generally the case that a more complex profiling scheme will incur a greater overhead. Thus, dynamic translators typically have to strike a balance between minimizing overhead on the one hand and selecting hot spots very carefully on the other.

Depending on the profiling technique used, the granularity of the selected hot spots can vary. For example, a fine-grained technique may identify single blocks (a straight-line sequence of code without any intervening branches), whereas a more coarse approach to profiling may identify entire procedures. A procedure is a self-contained piece of code that is accessed by a call/branch instruction and typically ends with an indirect branch called a return. Since there are typically many more blocks that are executed compared to procedures, the latter requires much less profiling overhead (both memory space for the execution frequency counters and the time spent updating those counters) than the former. In systems that are performing program optimization, another factor to consider is the likelihood of useful optimization and/or the degree of optimization opportunity that is available in the selected hot spot. A block presents a much smaller optimization scope than a procedure (and thus fewer types of optimization techniques can be applied), although a block is easier to optimize because it lacks any control flow (branches and joins).

Traces offer yet a different set of tradeoffs. Traces (also known as paths) are single-entry multi-exit dynamic sequences of blocks. Although traces often have an optimization scope between that for blocks and that for procedures, traces may pass through several procedure bodies, and may even contain entire procedure bodies. Traces offer a fairly large optimization scope while still having simple control flow, which makes optimizing them much easier than a procedure. Simple control flow also allows a fast optimizer implementation. A dynamic trace can even go past several procedure calls and returns, including dynamically linked libraries (DLLs). This ability allows an optimizer to perform inlining, which is an optimization that removes redundant call and return branches, which can improve performance substantially.

Unfortunately, without hardware support, the overhead required to profile hot traces using existing methods (such as described by T. Ball and J. Larus in “Efficient Path Profiling”, Proceedings of the 29th Symposium on Micro Architecture (MICRO-29), December 1996) is often prohibitively high. Such methods require instrumenting the program binary (invasively inserting instructions to support profiling), which makes the profiling non-transparent and can result in binary code bloat. Also, execution of the inserted instrumentation instructions slows down overall program execution and once the instrumentation has been inserted, it is difficult to remove at runtime. In addition, such a method requires sufficiently complex analysis of the counter values to uncover the hot paths in the program that such method is difficult to use effectively on-the-fly while the program is executing. All of these factors make traditional schemes inefficient for use in a caching dynamic translator.

Hot traces can also be constructed indirectly, using branch or basic block profiling (as contrasted with trace profiling, where the profile directly provides trace information). In this scheme, a counter is associated with the Taken target of every branch (there are other variations on this, but the overheads are similar). When the caching dynamic translator is interpreting the program code, it increments such a counter each time a Taken branch is interpreted. When a counter exceeds a preset threshold, its corresponding block is flagged as hot. These hot blocks can be strung together to create a hot trace. Such a profiling technique has the following shortcomings:

1. A large counter table is required, since the number of distinct blocks executed by a program can be very large.

2. The overhead for trace selection is high. The reason can be intuitively explained: if a trace consists of N blocks, this scheme will have to wait until N counters all exceed their thresholds before they can be strung into a trace.

### SUMMARY OF THE INVENTION

Briefly, the present invention comprises, in one embodiment, a method for growing a hot trace in a program during the program's execution in a dynamic translator, comprising the steps of: identifying an initial block; and starting with the initial block, growing the trace block-by-block by applying static branch prediction rules until an end-of-trace condition is reached.

In a further aspect of the present invention, a method is provided for growing a hot trace in a program during the program's execution in a dynamic translator, comprising the steps of: identifying an initial block as the first block in a trace to be selected; until an end-of-trace condition is reached, applying static branch prediction rules to the terminating branch of a last block in the trace to identify a next block to be added to the selected trace; and adding the identified next block to the selected trace.

In a further aspect of the present invention, the method includes the step of storing the selected traces in a code cache.

In a yet further aspect of the present invention, the end-of-trace condition includes at least one of the following conditions: (1) no prediction rule applies; (2) a total number of instructions in the trace exceeds a predetermined limit; (3) cumulative estimated prediction accuracy has dropped below a predetermined threshold.

In a further aspect of the present invention, the prediction rules include both rules for predicting the outcomes of branch conditions and for predicting the targets of branches.

In yet a further aspect of the present invention, an initial block is identified by maintaining execution counts for targets of branches and when an execution count exceeds a threshold, identifying as an initial block, the block that begins at the target of that branch and extends to the next branch.

In a further aspect of the present invention, the set of static branch prediction rules comprises: determining if the branch instruction is unconditional; and if the branch instruction is unconditional, then adding the target instruction of the branch instruction and following instructions through the next branch instruction to the hot trace.

In a further aspect of the present invention, the set of static rules comprises: determining if a target instruction of the branch instruction can be determined by symbolically evaluating a branch condition of the branch instruction; and if the target instruction of the branch instruction can be determined symbolically, then adding the target instruction and following instructions through the next branch instruction to the hot trace.

In a further aspect of the invention, the set of static rules comprises: determining if a heuristic rule can be applied to the branch instruction; and if a heuristic rule can be applied to the branch instruction, then the branch instruction is determined to be Not Taken.

In a yet further aspect of the present invention, the method further comprises the step of changing a count in a confidence counter if a heuristic rule can be applied to the branch instruction; and determining whether the confidence counter has reached a threshold level.

In yet a further aspect of the invention, the set of static rules comprises: determining whether the branch instruction is a procedure return; and if the branch instruction is a procedure return, then determining if there has been a corresponding branch and link instruction on the hot trace; if there has been a corresponding branch and link instruction, then determining if there is an instruction in the hot trace between the corresponding branch and link instruction and the procedure return that modifies a value in a link register associated with the corresponding branch and link instruction; and if there is no instruction that modifies the value in the link register between the corresponding branch and link instruction and the procedure return, then adding an address of a link point and following instructions up through a next branch instruction to the hot trace.

In a further aspect of the present invention, the method further comprises the steps of: storing a return address in a program stack; wherein the step of determining if there is an instruction that modifies the value in the link register comprises forward monitoring hot trace instructions between the corresponding branch and link instruction and the return for instructions that change a value in a link register associated with the corresponding branch and link instruction.

In a further aspect of the present invention, the method further comprises maintaining a confidence count that is incremented or decremented by a predetermined amount based on which static branch prediction rule has been applied; and if the confidence count has reached a second threshold level, ending the growing of the hot trace.

In a further aspect of the present invention, the identifying an initial block step comprises associating a different count with each different target instruction in a selected set of target instructions and incrementing or decrementing that count each time its associated target instruction is executed; and identifying the target instruction as the beginning of the initial block if the count associated therewith exceeds a hot threshold. The selected set of target instructions may include target instructions of backwards taken branches and target instructions from an exit branch from a trace in a code cache.

In a further embodiment of the present invention, a dynamic translator is provided for growing a hot trace in a program during the program's execution in a dynamic translator, comprising: first logic for identifying an initial block as the first block in a trace to be selected; second logic for, until an end-of-trace condition is reached, applying branch prediction rules to the terminating branch of the last block in the trace to identify a next block to be added to the selected trace; and third logic for adding the identified next block to the selected trace.

In yet a further embodiment of the present invention, a computer program product is provided, comprising: a computer usable medium having computer readable program code embodied therein for growing a hot trace in a program during the program's execution in a dynamic translator, comprising first code for identifying an initial block as the first block in a trace to be selected; second code for, until an end-of-trace condition is reached, applying branch prediction rules to the terminating branch of the last block in the trace to identify a next block to be added to the selected trace; and third code for adding the identified next block to the selected trace.

### BRIEF DESCRIPTION OF THE DRAWING

The invention is pointed out with particularity in the appended claims. The above and other advantages of the invention may be better understood by referring to the following detailed description in conjunction with the drawing, in which:

FIG. 1 is a block diagram illustrating the components of a dynamic translator such as one in which the present invention can be employed;

FIG. 2 is a flowchart illustrating the flow of operations in accordance with the present invention; and

FIG. 3 is a flowchart illustrating the flow of operations in accordance with the present invention.

### DETAILED DESCRIPTION OF AN ILLUSTRATIVE EMBODIMENT

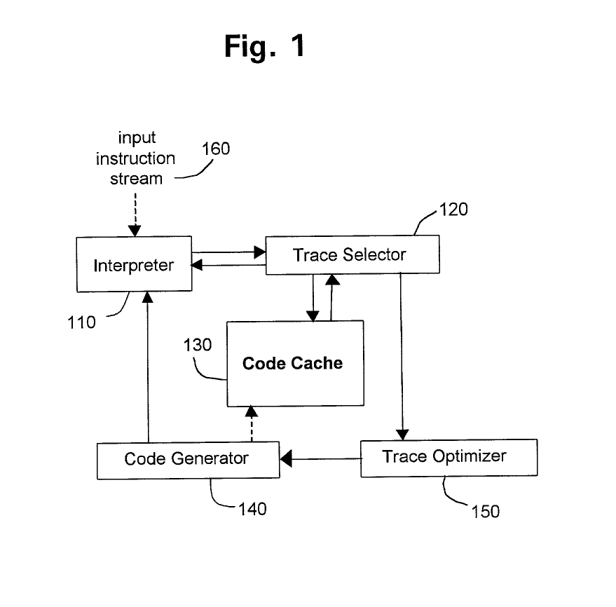

Referring to FIG. 1, a dynamic translator includes an interpreter 110 that receives an input instruction stream 160. This “interpreter” represents the instruction evaluation engine; it can be implemented in a number of ways (e.g., as a software fetch-decode-eval loop, a just-in-time compiler, or even a hardware CPU).

In one implementation, the instructions of the input instruction stream 160 are in the same instruction set as that of the machine on which the translator is running (native-to-native translation). In the native-to-native case, the primary advantage obtained by the translator flows from the dynamic optimization 150 that the translator can perform. In another implementation, the input instructions are in a different instruction set than the native instructions.

A trace selector 120 is provided to identify instruction traces to be stored in the code cache 130. The trace selector is the component responsible for associating counters with interpreted program addresses, determining when a “hot trace” has been detected, and growing the hot trace.

Much of the work of the dynamic translator occurs in an interpreter-trace selector loop. After the interpreter 110 interprets a block of instructions (i.e., until a branch), control is passed to the trace selector 120 so that it can select traces for special processing and placement in the cache. The interpreter-trace selector loop is executed until one of the following conditions is met: (a) a cache hit occurs, in which case control jumps into the code cache, or (b) a hot start-of-trace is reached.

When a hot start-of-trace is found, the trace selector 120 then begins to grow the hot trace. When an end-of-trace condition is reached, then the trace selector 120 invokes the trace optimizer 150. The trace optimizer is responsible for optimizing the trace instructions for better performance on the underlying processor. After optimization is completed, the code generator 140 emits the trace code into the code cache 130 and returns to the trace selector 120 to resume the interpreter-trace selector loop. For an application on similar technology, see “Low Overhead Speculative Selection of Hot Traces in a Caching Dynamic Translator,” by Vasanth Bala and Evelyn Duesterwald, Ser. No. 09/312,296, filed on May 14, 1999.

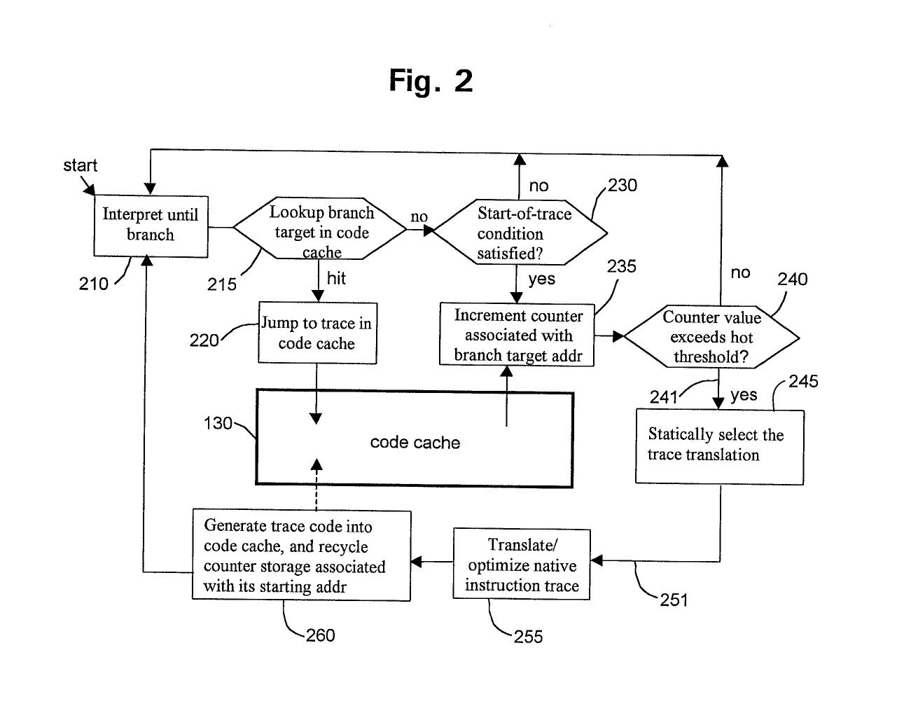

FIG. 2 illustrates operation of an implementation of a dynamic translator employing the present invention. The solid arrows represent flow of control, while the dashed arrow represents the generation of data. In this case, the generated “data” is actually executable sequences of instructions (traces) that are being stored in the translated code cache 130.

After trace selection by the trace selector 245, the trace selected is translated into a native instruction stream and then stored in the translated code cache 130 for execution, without the need for interpretation the next time that portion of the program is executed (unless intervening factors have resulted in that code having been flushed from the cache).

The trace selector 245 is exploited in the present invention as a mechanism for identifying the extent of a trace; not only does the trace selector 245 generate data (instructions) to be stored in the cache, it plays a role in trace selection process itself. The present invention initiates trace selection based on limited profiling: certain addresses that meet start-of-trace conditions are monitored, without the need to maintain profile data for entire traces. A trace is selected based on a hot start-of-trace condition. At the time a start-of-trace is identified as being hot (based on the execution counter exceeding a threshold), the extent of the instructions that make up the trace is not known.

Referring to FIG. 2, the dynamic translator starts by interpreting instructions until a taken branch is interpreted at block 210. At that point, a check is made to see if a trace that starts at the target of the taken branch exists in the code cache 215. If there is such a trace (i.e., a cache ‘hit’), execution control is transferred to block 220 to the top of that version of the trace that is stored in the cache 130.

When, after executing instructions stored in the cache 130, control exits the cache via an exit branch, a counter associated with the exit branch target is incremented in block 235 as part of a “trampoline” instruction sequence that is executed in order to hand execution control back to the dynamic translator. In this regard, when the trace is formed for storage in the cache 130, a set of trampoline instructions is included in the trace for each exit branch in the trace. These instructions (also known as translation “epilogue”) transfer execution control from the instructions in the cache back to the interpreter trace selector loop. An exit branch counter is associated with the trampoline corresponding to each exit branch. Like the storage for the trampoline instructions for a cached trace, the storage for the trace exit counters is also allocated automatically when the native code for the trace is emitted into the translated code cache. In the illustrative embodiment, as a matter of convenience, the exit counters are stored with the trampoline instructions; however, the counter could be stored elsewhere, such as in an array of counters. Note that these exit branch/trampoline instructions are considered to be start-of-trace instructions.

Referring again to 215 in FIG. 2, if, when the cache is checked for a trace starting at the target of the taken branch, no such trace exists in the cache, then a determination is made as to whether a “start-of-trace” condition exists 230. In the illustrative embodiment, the start-of-trace condition is when the just interpreted branch was a backward taken branch, based on the sequence of the original program code. As noted above, another start-of-trace instruction condition is met by the target of an exit branch/trampoline instruction causing the exit of control from a translation in the code cache. Alternatively, a system could employ different start-of-trace conditions that may be combined with or may exclude backward taken branches, such as procedure call instructions, exits from the code cache, system call instructions, or machine instruction cache misses (if the hardware provided some means for tracking such activity).

A backward taken branch is a useful start-of-trace condition because it exploits the observation that the target of a backward taken branch is very likely to be (though not necessarily) the start of a loop. Since most programs spend a significant amount of time in loops, loop headers are good candidates as possible hot spot entrances. Also, since there are usually far fewer loop headers in a program than taken branch targets, the number of counters and the time taken in updating the counters is reduced significantly when one focuses on the targets of backward taken branches (which are likely to be loop headers) and the exit branches for traces that are already stored in the cache, rather than on all branch targets.

If the start-of-trace condition is not met, then control re-enters the basic interpreter state in block 210 and interpretation continues. In this case, there is no need to maintain a counter; a counter increment takes place only if a start-of-trace condition is met. This is in contrast to conventional dynamic translator implementations that maintain counters for each branch target. In the illustrative embodiment counters are only associated with the address of the backward taken branch targets and with targets of branches that exit the translated code cache; thus, the present invention permits a system to use less counter storage and to incur less counter increment overhead.

If the determination of whether a “start-of-trace” condition exists at block 230 is that the start-of-trace condition is met, then, if a counter for the target does not exist, one is created or if a counter for the target does exist, that that counter is incremented in block 235.

If the counter value for the branch target does not exceed the hot threshold in block 240, then control re-enters the basic interpreter state and interpretation continues at block 210.

If the counter value does exceed a hot threshold 240, then this branch target is the beginning of what will be deemed to be a hot trace. At this point, that counter value is no longer needed, and that counter can be recycled (alternatively, the counter storage could be reclaimed for use for other purposes). This is an advantage over profiling schemes that involve instrumenting the binary.

Because the profile data that is being collected by the start-of-trace counters is consumed on the fly (as the program to be translated is being executed), these counters can be recycled when its information is no longer needed; in particular, once a start-of-trace counter has become hot and has been used to select a trace for storage in the cache, that counter can be recycled. The illustrative embodiment includes a fixed size table of start-of-trace counters. The table is associative—each counter can be accessed by means of the start-of-trace address for which the counter is counting. When a counter for a particular start-of-trace is to be recycled, that entry in the table is added to a free list, or otherwise marked as free.

The lower the threshold in block 240, the less time is spent in the interpreter, and the greater the number of start-of-traces that potentially get hot. This results in a greater number of traces being generated into the code cache (and the more speculative the choice of hot traces), which in turn can increase the pressure on the code cache resources, and hence the overhead of managing the code cache. On the other hand, the higher the threshold, the greater the interpretive overhead (e.g., allocating and incrementing counters associated with start-of-traces). Thus the choice of threshold has to balance these two forces. It also depends on the actual interpretive and code cache management overheads in the particular implementation. In our specific implementation, where the interpreter was written as a software fetch-decode-eval loop in C, a threshold of 50 was chosen as the best compromise.

If the counter value does exceed the hot threshold in block 240, then, as indicated above, the address corresponding to that counter will be deemed to be the start of a hot trace and the execution of the program being executed is temporarily halted. At the time the trace is identified as hot, the extent of the trace remains to be determined (by the trace selector described below). Also, note that the selection of the trace as ‘hot’ is speculative, in that only the initial block of the trace has actually been measured to be hot.

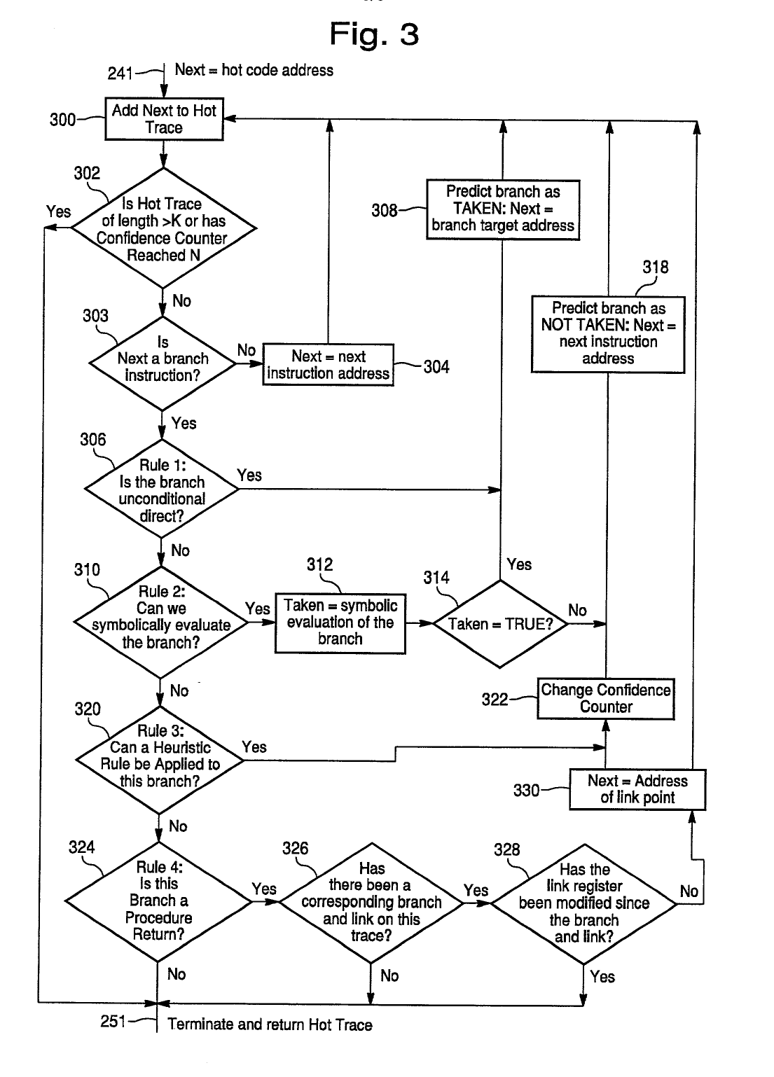

Referring now to FIG. 3, there is shown a flow diagram for a program and method for growing a hot trace, which method may be used during this halt in the execution of the program being translated, or alternatively, during program runtime. The intent of the invention is to extend the ideal of caching to speed up emulators by using much larger and non-consecutive code regions in the cache for translation. In accordance with the present invention, when creating a hot trace, the emulator or dynamic translator speculates on the future outcome of branches using static branch prediction rules. By the term “static branch prediction” is meant that the program text is inspected and used to make branch predictions, but dynamic information such as runtime execution histories, are not used to make predictions. Accordingly, only the program code is inspected in order to implement the present invention. It should be noted that the terms “control” and “execution control” during this temporary halt period mean execution of the trace selector program, and not the program being translated. The benefits of this scheme depend on how well future branch behavior is predicted. Each hot trace to be stored in the cache starts at the target of a branch and extends across several basic blocks. A list of instructions or basic blocks to be added to the hot trace is constructed based on statically predicted branch outcomes. The list is grown in up to K steps. During each step the terminating branch of the basic block that was last collected for the hot trace is inspected. Depending on the nature of the branch, a prediction is made to determine the branch outcome and the corresponding successor block instruction or block in the trace. The trace growing process terminates after K steps, or if a branch is encountered for which no prediction rules apply. There are two types of branch prediction rules: rules for predicting the outcome of direct branches and rules for predicting the target of indirect branches. The rules for direct branches are either local or global direct prediction rules.

A local direct branch prediction rule considers each branch in isolation and arrives at a prediction solely based on the condition code and operands of the branch. For example, see Ball and Larus, “Branch Prediction for Free”, Proceedings of the 1993 ACM SIGPLANC Conference on Programming Language Design and Implementation. Note that most programs use branches that test whether a value is less than zero to identify error conditions, which is an unlikely event. The corresponding prediction rule is to predict every branch that tests whether a value is less than zero as Not Taken. Unconditional direct branches are always predicted as taken.

Global direct branch prediction rules take branch correlation into account. Thus, a branch prediction is made based on the branches that have previously been inspected, i.e., a semantic correlation exists among branch outcomes. For example, if the outcome of one branch implies the outcome of a later branch, then this is a semantic correlation. By way of example, consider a branch that tests whether the value in a register is less than zero and assume that this branch was predicted as Not Taken. Assume that the next branch encountered along the fall-through successor (the target Not Taken) is a branch that tests whether the same register value is greater than or equal to zero. Clearly this later branch must be Taken in view of the previous prediction that the register value is not less than zero. Accordingly, it can be seen that with global direct branches, the outcome can be predicted simply by looking at the predicted outcomes of earlier branches.

In contrast, indirect branches have targets that cannot be immediately predicted by decoding the branch condition. By way of example, an indirect branch instruction might jump to a location given by the value in register A. Since the value in register A can be different for each different execution, the target for this branch cannot be immediately predicted. Thus, indirect branch targets are not predicted unless they represent procedure returns that can be inlined. The inline rule assumes a calling convention using a branch and link instruction, wherein a dedicated register called the link register is used as a return pointer for the procedure. If the procedure calls and returns do not follow the assumed calling convention, inlining opportunities will be missed, but the generated translation will still be correct and valid.

In order to inline, because the program being translated is temporarily halted so that the contents of the link register cannot be read, it is necessary to walk back through the code in the hot trace until the link and return instruction is encountered that is associated with the particular return instruction of interest. Note that in most situations, the return address, i.e., link point, will be the next instruction contiguously following the associated branch and link instruction. It is also necessary to determine the validity of the return address, because it is possible that one of the instructions following the link and return instruction changes the value held in the link register. Accordingly, the validity of the return address can be ensured by checking/inspecting the instructions during the backwards pass/walk back through the hot trace instruction during the search for the associated branch and link instruction. If this inspection identifies an instruction that modifies the contents of the link register, then the return address in the link register is invalid and the hot trace growing program is terminated.

In accordance with a further aspect of the present invention, to speed the inlining of procedure calls and returns, a return address stack in the trace growing program is provided. Each time a procedure call/branch and link is encountered during the trace selection and the return address stack is not empty, the corresponding return address to jump to once the execution of the procedure is completed is pushed onto the return address stack. The use of a return address stack is an optimization to avoid the need to walk back through the code in the hot trace. As noted above, in most situations, the return address/link point will be the next instruction contiguously following the branch and link instruction. When an indirect branch that represents a procedure return is encountered, the indirect branch target is determined by simply popping the return address from the return address stack. The validity of the return address is ensured by checking/inspecting the instructions that follow the branch and link instruction up to the corresponding return instruction in order to determine whether any of these inspected instructions modifies the contents of the link register. This inspection takes place during a forward pass through the instructions following the branch and link instruction during the trace growing program. If this inspection identifies an instruction that modifies the contents of the link register, then this return address stack is invalidated. Otherwise, the value in the return address stack is valid.

Referring more specifically to FIG. 3, the starting address for the hot trace which has been identified in block 240 (shown in FIG. 2), is applied via line 241 to block 300. Note that this starting address is designated as Next. The block 300 causes the execution to add this Next address to the hot trace being constructed in a buffer. The next step in the trace selection execution is to determine whether the hot trace being constructed in the buffer is of a length which is greater than K and to also determine whether the confidence counter has reached N. K represents a predetermined number of instructions which is set in order to prevent errors such as unlimited growth in the trace which, for example, can result from unfolding loops. The confidence counter determination will be discussed during a later execution step. If the hot trace has a length greater than K or the confidence counter has reached N, then the execution terminates the hot trace creation and the output of the hot trace instructions are applied on line 251 to the optimize native instruction trace block 255 in FIG. 2. If the hot trace is not of a length greater than K or the confidence counter has not reached N, then the execution moves to block 302.

Block 302 is a decision step to determine if this Next instruction is a branch instruction. If the Next instruction is not a branch instruction, then Next is made equal to the next contiguous instruction address following the current Next instruction address in block 304. This new Next instruction address is added to the hot trace in block 300 and the procedure begins again. Alternatively, if the Next instruction is a branch instruction, then the execution moves to block 306.

Block 306 is a decision block which determines if the branch instruction is an unconditional direct branch. If the branch instruction is an unconditional direct branch, then the execution moves to block 308 which determines that the branch is TAKEN and the Next is set equal to the target address for this unconditional branch instruction. This new Next instruction is then moved to the execution block 300 and is added to the hot trace in the buffer. Alternatively, if the branch instruction is conditional, then the execution moves to block 310.

Block 310 is a decision block which determines whether the condition of the branch instruction can be symbolically evaluated. By way of example, is the condition evaluated directly or by implication by an earlier instruction. For example, if a previous branch had tested whether a given register value is less than zero and that was predicted as Not Taken, then for a condition of whether the same register value is greater than or equal to zero, that condition can now be symbolically evaluated and the branch determined as Taken. If it is determined in block 310 that the condition of the branch can be symbolically evaluated, then the execution moves to block 312 wherein the symbolic evaluation is determined. Then the trace selection program execution moves to decision block 314 to determine whether the symbolic evaluation yielded information that the branch is Taken. If the branch is Taken, then the execution moves to block 308 and the branch is predicted as Taken, Next is set equal to the branch target address, and the execution moves to block 300 where the new Next is added to the hot trace in the buffer. Alternatively, if the decision in block 314 is that the branch is Not Taken, then the execution moves to block 318.

Block 318 predicts that the branch is Not Taken and Next is set equal to the next instruction address contiguously following the branch instruction under consideration. This new Next is then applied to block 300 where it is added to the hot trace in the buffer and the cycle begins again.

Referring again to block 310, if it is determined that the branch instruction cannot be symbolically evaluated, then the execution moves to block 320. This decision block 320 determines whether a heuristic rule can be applied to the branch. Heuristic rules apply to conditional direct branch instructions. All heuristic rules are local and static, that is, only the branch instruction itself is inspected and no additional information is used to make the prediction. Examples of heuristic rules are as follows:

Comparison against Zero: if the branch condition compares a register value against zero, then predict the branch as Not Taken;

Forward Branch Rule: if the branch target is nearby, that is for example, within the next six instructions forward, predict the branch as Not Taken;

Equality Test: if the branch condition compares two registers for equality predict the branch as Not Taken;

Inequality Test: if the branch condition compares two registers for inequality predict the branch as Taken.

If a heuristic rule can be applied to the branch, then the execution moves to block 322 wherein a confidence counter is changed. Note that the confidence counter may be incremented by various values including “1”. The purpose of this confidence counter is to indicate how many predictions have been made for heuristic branch conditions. When the number of predictions for heuristic branches reaches N, then it is preferred that the hot trace be ended, based on the assumption that when the number of heuristic branch predictions reaches N, then the confidence level in the predictions begins to drop significantly.

The execution then moves from block 322 to block 318, wherein it is predicted that the branch is Not Taken and Next is set equal to the next contiguous instruction following the branch instruction address. The execution then moves to the block 300 wherein this new Next is added to the hot trace in the buffer. Note that the count in the Confidence Counter is tested in the decision block 302, as previously noted.

Note that a generic confidence counter may be utilized that is incremented or decremented by an amount for each, or for only a predetermined set, of branch predictions made, and/or it may be incremented using a function that depends on the current branch prediction rule and one or more previously applied branch prediction rules. This generic confidence counter may be incremented or decremented by different amounts, depending on the branch prediction rule, with the amounts reflecting the degree of risk/uncertainty associated with the branch prediction made according to that rule.

If it is determined in block 320 that a heuristic rule cannot be applied to the branch instruction, then the execution moves to block 324. This decision block 324 determines whether this branch instruction is a procedure return. If it is determined that this branch instruction is a procedure return, then the trace selection program execution moves to block 326 wherein it is determined whether there is a corresponding branch and link instruction associated with the return on the hot trace. If the determination is that there is no corresponding branch and link instruction, then the execution terminates the creation of the hot trace and the execution moves to block 255. Alternatively, if block 326 determines that there has been a corresponding branch and link instruction, then the execution moves to block 328. Note that such a branch and link instruction would be indicated in the preferred embodiment, by the presence of a value in the return stack. Block 328 determines whether the link register associated with the branch and link instruction has been modified since the branch and link instruction. In this regard, the instructions in the hot trace between the branch and link instruction and the return instruction are inspected by stepping backwards through the instructions from the branch that is a procedure return to the branch and link instruction that is associated with this procedure return to determine whether any instructions in this interim group of instructions causes the link register associated with this branch and link instruction to be modified. Alternatively, in the preferred embodiment, the validation could be performed after pushing the return value onto the return stack and inspecting the instructions between the branch and link instruction and the return instruction in a forward pass. If the link register containing the return point address has not been modified since the branch and link instruction, then the execution moves to block 330 wherein Next is set equal to the address of the instruction set forth in the link register. The execution then moves to block 300 wherein this new Next instruction is added to the hot trace in the buffer and the cycle begins again.

Alternatively, if it is determined in block 328 that the link register has been modified since the associated branch and link instruction, then the execution terminates the creation of the hot trace and the execution moves to block 255 in FIG. 2.

If it is determined in block 324 that the branch instruction is not a procedure return, then the execution terminates the creation of the hot trace and the execution moves to block 255 in FIG. 2.

It should be noted that after a list of instructions in the hot trace has been constructed, a trace translation is obtained by translating each instruction. The predicted branches are adjusted to follow the direction of the trace as follows: (1) direct unconditional branches are simply eliminated; (2) direct conditional branches that are predicted Taken, are translated by inverting the sense of the branch condition and updating the new target as the original fall-through address; and (3) indirect branches such as a procedure that has a predicted return point can be eliminated.

It should be noted that the present description of FIG. 3 has been made in the context of instructions. However, it should be understood by one of ordinary skill in the art that this description can be viewed in terms of basic blocks, with each basic block of instructions ending with a branch instruction.

The present invention significantly speeds up emulation by improving execution time of the translated code, rather than by reducing emulation overhead. By predicting and fetching sequences of instructions/basic blocks, the predicted blocks do not have to become hot individually before being placed into the cache. Thus, profiling overhead can be reduced compared with a block based caching scheme. Importantly, no additional profiling information is needed in order to select the traces since trace selection is based entirely on static prediction rules.

Independent of the prediction based static selection mechanism, translating larger traces rather than single basic blocks opens up three important performance advantages. First, the blocks that constitute a hot region are likely to be contained in the same traces, thereby improving the code locality in the translation cache.

Second, translating traces across basic block boundaries leads to a new layout of the code. By re-laying out branches in the translation cache, the translation prediction scheme offers the opportunity to improve the branching behavior of the executing program compared to a block-based caching translator, and even compared to the original binary. When considering only basic blocks, a block does not have a fall-through successor, so that each block terminates with two branches and exactly one of them will take. When considering hot traces constructed in accordance with the present invention, each internal block in the hot trace has a fall-through successor and a branch is only taken when exiting the trace. Moreover, if a procedure call had been inlined, call and return branches entirely disappear within the trace. Thus, the trace prediction scheme will always lead to fewer branches being executed compared to a block based translation scheme, in the presence of call and return inlining, and possibly even compared to the original binary. Depending on the quality of the predictions, execution will follow more or less the direction of the hot traces. Thus, the prediction scheme may also lead to fewer branches being taken, which, depending on the underlying platform, may be an additional performance advantage.

The third advantage of using sequences of basic blocks created in the hot trace of the present invention is that optimization opportunities are exposed that only arise across basic block boundaries and are thus not available to the basic block translator. Procedure call and return inlining is an example of such an optimization. Other optimization opportunities arising from the use of a dynamic translator using the hot trace creation of the present invention include classical compiler optimizations such as redundant load removal. These trace optimizations provide a further performance boost to the emulator.

The limit K on the number of instructions in a trace is chose to avoid excessively long traces. In the illustrative embodiment, this is 1024 instructions, which allows a conditional branch on the trace to reach its extremities (this follows from the number of displacement bits in the conditional branch instruction on the PA-RISC processor, on which the illustrative embodiment is implemented).

The illustrative embodiment of the present invention is implemented as software running on a general purpose computer, and the present invention is particularly suited to software implementation. Special purpose hardware can also be useful in connection with the invention (for example, a hardware ‘interpreter’, hardware that facilitates collection of profiling data, or cache hardware).

The foregoing has described a specific embodiment of the invention. Additional variations will be apparent to those skilled in the art. For example, although the invention has been described in the context of a dynamic translator, it can also be used in other systems that employ interpreters or just-in-time compilers (JITs). Further, the invention could be employed in other systems that emulate any non-native system, such as a simulator. Thus, the invention is not limited to the specific details and illustrative example shown and described in this specification. Rather, it is the object of the appended claims to cover all such variations and modifications as come within the true spirit and scope of the invention.

We claim:

1. A method for growing a hot trace in a program during the program's execution in a dynamic translator, comprising the steps of:
identifying an initial block; and
starting with the initial block, growing the trace block-by-block by applying static branch prediction rules until an end-of-trace condition is reached.

2. A method for growing a hot trace in a program during the program's execution in a dynamic translator, comprising the steps of:
identifying an initial block as the first block in a trace to be selected;
until an end-of-trace condition is reached, applying static branch prediction rules to the terminating branch of a last block in the trace to identify a next block to be added to the selected trace; and
adding the identified next block to the selected trace.

3. The method as defined in claim 2, in further comprising the step of storing the selected traces in a code cache.

4. The method of claim 2, in which the end-of-trace condition includes at least one of the following conditions:
(1) no prediction rule applies; (2) a total number of instructions in the trace exceeds a predetermined limit; (3) cumulative estimated prediction accuracy has dropped below a predetermined threshold.

5. The method as defined in claim 2, in which the prediction rules include both rules for predicting the outcomes of branch conditions and for predicting the targets of branches.

6. The method as defined in claim 2, in which an initial block is identified by maintaining execution counts for targets of branches and when an execution count exceeds a threshold, identifying as an initial block, the block that begins at the target of that branch and extends to the next branch.

7. The method claim 2, wherein said set of prediction rules comprises:
for the branch instruction, determining whether to add a target instruction of the branch instruction to the hot trace based on said set of static branch prediction rules.

8. The method as defined in claim 7, wherein said set of static branch prediction rules comprises:
determining if said branch instruction is unconditional; and
if said branch instruction is unconditional, then adding the target instruction of the branch instruction and following instructions through the next branch instruction to the hot trace.

9. The method as defined in claim 7, wherein said set of static rules comprises:
determining if a target instruction of said branch instruction can be determined by symbolically evaluating a branch condition of said branch instruction; and
if said target instruction of said branch instruction can be determined symbolically, then adding the target instruction and following instructions through the next branch instruction to the hot trace.

10. The method as defined in claim 7, wherein said set of static rules comprises:
determining if a heuristic rule can be applied to said branch instruction; and
if a heuristic rule can be applied to said branch instruction, then the branch instruction is determined to be Not Taken.

11. The method as defined in claim 9, wherein said set of static branch prediction rules comprises:
determining if a heuristic rule can be applied to said branch instruction; and
if a heuristic rule can be applied to said branch instruction, then the branch instruction is determined to be Not Taken.

12. The method as defined in claim 10, further comprising the step of changing a count in a confidence counter if said heuristic rule can be applied to the branch instruction; and determining whether said confidence counter has reached a threshold level.

13. The method as defined in claim 7, wherein said set of static rules comprises:
determining whether said branch instruction is a procedure return; and
if said branch instruction is a procedure return, then determining if there has been a corresponding branch and link instruction on said hot trace;
if there has been a corresponding branch and link instruction, then determining if there is an instruction in the hot trace between said corresponding branch and link instruction and the procedure return that modifies a value in a link register associated with the corresponding branch and link instruction; and
if there is no instruction that modifies the value in said link register between said corresponding branch and link instruction and the procedure return, then adding an address of a link point and following instructions up through a next branch instruction to the hot trace.

14. The method as defined in claim 11, wherein said set of static rules comprises:
determining whether said branch instruction is a procedure return; and
if said branch instruction is a procedure return, then determining if there has been a corresponding branch and link instruction on said hot trace; and
if there has been a corresponding branch and link instruction, then determining if there is an instruction in the hot trace between said corresponding branch and link instruction and the procedure return that modifies a value in a link register associated with the corresponding branch and link instruction; and
if there is no instruction that modifies the value in said link register between said corresponding branch and link instruction and the procedure return, then adding an address of a link point and following instructions up through the next branch instruction to the hot trace.

15. The method of claim 13, further comprising the steps:
storing a return address in a program stack;
wherein said step of determining if there is an instruction that modifies the value in the link register comprises forward monitoring hot trace instructions between the corresponding branch and link instruction and the return for instructions that change a value in a link register associated with said corresponding branch and link instruction.

16. The method of claim 2, further comprising a confidence count that is incremented or decremented by a predetermined amount based on which static branch prediction rule has been applied; and
if said confidence count has reached a second threshold level, ending the growing of the hot trace.

17. The method of claim 2, wherein said identifying an initial block step comprises associating a different count with each different target instruction in a selected set of target instructions and incrementing or decrementing that count each time its associated target instruction is executed; and
identifying said target instruction as the beginning of said initial block if the count associated therewith exceeds a hot threshold.

18. The method of claim 17, wherein said selected set of target instructions includes target instructions of backwards taken branches and target instructions from an exit branch from a trace in a code cache.

19. The method of claim 2, wherein the end-of-trace condition comprises when a total number of instructions in the trace exceeds a predetermined limit.

20. A dynamic translator for growing a hot trace in a program during the program's execution in a dynamic translator, comprising:
first logic for identifying an initial block as the first block in a trace to be selected;
second logic for, until an end-of-trace condition is reached, applying static branch prediction rules to the terminating branch of the last block in the trace to identify a next block to be added to the selected trace; and
third logic for adding the identified next block to the selected trace.

21. A computer program product, comprising:
a computer usable medium having computer readable program code embodied therein for growing a hot trace in a program during the program's execution in a dynamic translator, comprising
first code for identifying an initial block as the first block in a trace to be selected;
second code for, until an end-of-trace condition is reached, applying static branch prediction rules to the terminating branch of the last block in the trace to identify a next block to be added to the selected trace; and
third code for adding the identified next block to the selected trace.
